(19) United States
(12) Patent Application Publication
(10) Pub. No.: US 2025/0234383 A1
(43) Pub. Date: Jul. 17, 2025

(54) COMMUNICATION APPARATUS, COMMUNICATION METHOD, AND RECORDING MEDIUM

(71) Applicant: CANON KABUSHIKI KAISHA, Tokyo (JP)

(72) Inventor: MITSUYOSHI YUKAWA, Kanagawa (JP)

(21) Appl. No.: 19/173,144

(22) Filed: Apr. 8, 2025

Related U.S. Application Data
(63) Continuation of application No. PCT/JP2023/036461, filed on Oct. 6, 2023.

(30) Foreign Application Priority Data
Oct. 14, 2022 (JP) 2022-165565

(51) Int. Cl. H04W 74/0816; H04W 84/12

(52) U.S. Cl. CPC H04W 74/0816; H04W 84/12

(57) ABSTRACT

A communication apparatus includes a first transmission unit configured to transmit a first Trigger frame conforming to the IEEE 802.11 series standard, the first Trigger frame instructing that at least one first communication apparatus participating in a wireless network performs communication by using a first time period which is at least a part of a Transmission Opportunity (TXOP) acquired by the communication apparatus, and a second transmission unit configured to transmit, in a case where communication of data to be communicated during the first time period ends, a second Trigger frame instructing that a second communication apparatus different from the first communication apparatus newly performs communication by using a second time period which is at least a part of the acquired TXOP.

### CROSS-REFERENCE TO RELATED APPLICATIONS

This application is a Continuation of International Patent Application No. PCT/JP2023/036461, filed Oct. 6, 2023, which claims the benefit of Japanese Patent Application No. 2022-165565, filed Oct. 14, 2022, both of which are hereby incorporated by reference herein in their entirety.

### BACKGROUND

### Field of the Technology

The present disclosure relates to transmission and reception of an operation parameter in wireless communication.

### Description of the Related Art

With the increase in the volume of communication data in recent years, communication technologies, such as wireless Local Area Network (LANs), are increasingly being developed. The Institute of Electrical and Electronic Engineers (IEEE) 802.11 standard series are known as major wireless LAN communication standards. The IEEE 802.11 standard series include the IEEE 802.11a/b/g/n/ac/ax standards. For example, IEEE 802.11ax standardizes a technique not only for achieving a throughput as high as 9.6 gigabits/seconds (Gbps) but also for improving the transmission rate under a congested situation, by using Orthogonal Frequency-Division Multiple Access (OFDMA) (see Japanese Patent Application Laid-Open No. 2018-50133).

A task group called IEEE 802.11be has been established as a successor standard aiming for further improvements of the throughput, frequency usage efficiency, and communication latency. With the IEEE802.11be standard, Multi-Link communication has been studied. In Multi-Link communication, for example, one Access Point (AP) establishes a plurality of links with one Station (STA) via a plurality of different frequency channels to perform parallel communication.

The IEEE802.11be standard proposes Triggered Transmission Opportunity (TXOP) sharing in which, by using a Trigger frame, an AP shares a part of the TXOP acquired by the AP with an STA participating in a network. The AP shares the acquired TXOP with an STA specified by the AP, and frame transmission to unspecified STAs is inhibited to avoid a useless transmission frame collision during the shared TXOP, whereby efficient communication is achieved.

As described above, with the IEEE802.11be standard, a method called Triggered TXOP sharing has been studied. In the Triggered TXOP sharing, the AP shares the acquired TXOP with the STA specified by the AP to improve the communication efficiency. With this method, however, the communication between the AP and the STA sharing the TXOP may end before the shared TXOP ends, which may result in inefficient use of the shared TXOP and lead to degradation in communication efficiency.

### SUMMARY

The present disclosure provides a method for performing communication using a shared Transmission Opportunity (TXOP) without degrading the communication efficiency.

A communication apparatus including one or more memories that store a set of instructions, and at least one processing circuit, wherein the communication apparatus is caused, by the at least one processing circuit executing the instructions and/or the at least one processing circuit itself operating, to perform operations including receiving a Trigger frame conforming to the IEEE 802.11 series standard, the Trigger frame instructing that communication is performed by sharing a first time period, which is at least a part of a TXOP acquired by the first communication apparatus having a role of establishing a wireless network, with at least one second communication apparatus different from the communication apparatus participating in the wireless network, communicating with the second communication apparatus based on the Trigger frame, and transmitting, in a case where the communication with the second communication apparatus based on the Trigger frame ends, a frame indicating the end to the first communication apparatus.

Further features of the present invention will become apparent from the following description of exemplary embodiments with reference to the attached drawings.

### BRIEF DESCRIPTION OF THE DRAWINGS

FIG. 1 is a diagram illustrating an example configuration of a wireless communication system according to an exemplary embodiment.

FIG. 2 is a diagram illustrating a hardware configuration of a communication apparatus according to an exemplary embodiment.

FIG. 3 is a diagram illustrating a functional configuration example of the communication apparatus according to an exemplary embodiment.

FIG. 4 is a sequence diagram illustrating a first exemplary embodiment.

FIG. 5 is a flowchart illustrating operation of an Access Point (AP) according to the first exemplary embodiment.

FIG. 6 is a sequence diagram illustrating a second exemplary embodiment.

FIG. 7 is a flowchart illustrating operation of an AP according to the second exemplary embodiment.

### DESCRIPTION OF THE EMBODIMENTS

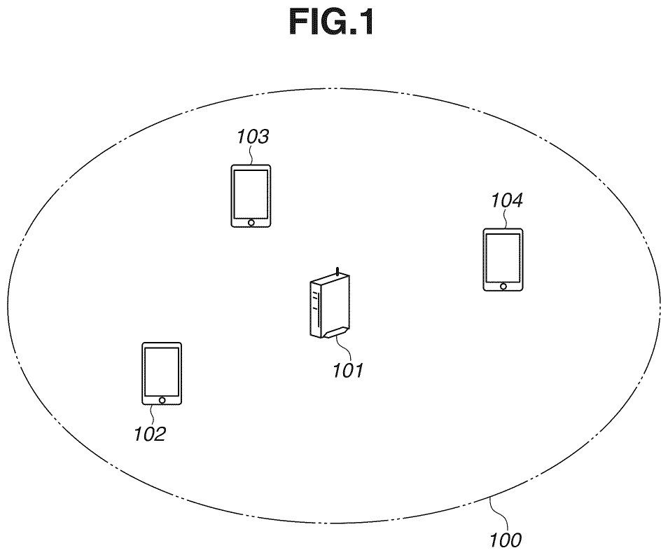

FIG. 1 illustrates an example configuration of a network in which a communication apparatus 101 according to the present exemplary embodiment participates. The communication apparatus 101 is capable of communicating with communication apparatuses 102 to 104 via a wireless Local Area Network (LAN). The communication apparatus 101 is an access point (AP) having a role of forming and establishing a wireless network 100. The communication apparatuses 102 to 104 are stations (STAs) having a role of participating in the wireless network 100.

Each of the communication apparatuses 101 to 104 can perform wireless communication conforming to the Institute of Electrical and Electronics Engineers (IEEE) 802.11 standard. While, in the following descriptions, the communication apparatuses 101 to 104 perform wireless communication conforming to the IEEE802.11be standard by using the 2.4 GHZ, 5 GHZ, and 6 GHz frequency bands as well as the 20 MHz, 40 MHZ, 80 MHZ, 160 MHz, and 320 MHz frequency bands, the present invention is not limited thereto. The communication apparatuses 101 to 104 may conform to at least one of the IEEE802.11a/b/g/n/ac/ax/be standards. In addition to the IEEE 802.11 standard series, each of the communication apparatuses 101 to 104 may conform to other communication standards such as Bluetooth®, Near Field Communication (NFC), Ultra Wide Band (UWB), ZigBee, and Multi Band OFDM Alliance (MBOA) UWB. UWB includes wireless Universal Serial Bus (USB), wireless 1394, and WiNET. Each of the communication apparatuses 101 to 104 may conform to communication standards of wired communication, such as a wired LAN.

The communication apparatuses 101 to 104 implement Multi-User (MU) communication in which signals of a plurality of users are multiplexed by orthogonal frequency-division multiple access (OFDMA) communication conforming to the IEEE 802.11be standard. In OFDMA communication, divided frequency bands (Resource Unit (RU)) are allocated without overlapping each other among STAs, and the carrier waves of different STAs are orthogonal to each other. This enables an AP to communicate with a plurality of STAs in parallel.

Specific examples of the communication apparatuses 101 to 104 include wireless LAN routers and personal computers (PCs). However, the present invention is not limited thereto. The communication apparatuses 101 to 104 may be wireless chips capable of performing wireless communication conforming to the IEEE 802.11be standard, or information processing apparatuses including a wireless chip. Specific examples of the communication apparatuses 102 to 104 include cameras, tablet computers, smart phones, PCs, mobile phones, and video cameras. However, the present invention is not limited thereto. The wireless network in FIG. 1 includes one AP and three STAs. However, the numbers of APs and STAs are not limited thereto.

A technique for allocating a part of a Transmission Opportunity (TXOP) acquired by an AP, by using a Trigger frame to each STA to share the TXOP is referred to as Triggered TXOP sharing. Transmission Opportunity (TXOP) refers to a time period during which an AP or STAs is permitted to exclusively use the channels after acquisition of the right to access channels by the AP or the STAs in EDCA-based contention control. With the Triggered TXOP sharing, the communication apparatus 101 serving as an AP allocates a part of the TXOP acquired as an AP to the communication apparatuses 102 to 104 serving as STAs and shares the acquired TXOP with the STAs. A TXOP period during which an AP and STAs share the TXOP acquired by the AP is referred to as a TXOP sharing period.

The Triggered TXOP sharing is started in response to the AP transmitting a Multi User-Request to Send TXOP sharing (MU-RTS TXS) Trigger frame to the STAs. In this case, the AP allocates a part of the acquired TXOP in the User Info field of the MU-RTS TXS Trigger frame and includes the Application Identifier (AID) of each STA to be permitted to perform communication. With the Triggered TXOP sharing, the MU-RTS TXS Trigger frame with Trigger Type of the Trigger frame specified for MU-RTS is used.

An STA to which a part of the TXOP acquired by the AP is allocated by using the MU-RTS TXS Trigger frame is allowed to transmit data to the AP or other STAs in the TXOP sharing period. Whether the communication between an STA and the AP or between STAs in the TXOP sharing period is specified by using the Triggered TXOP Sharing Mode subfield included in the Common Info field of the above-described Trigger frame.

### (Configurations of AP and STAs)

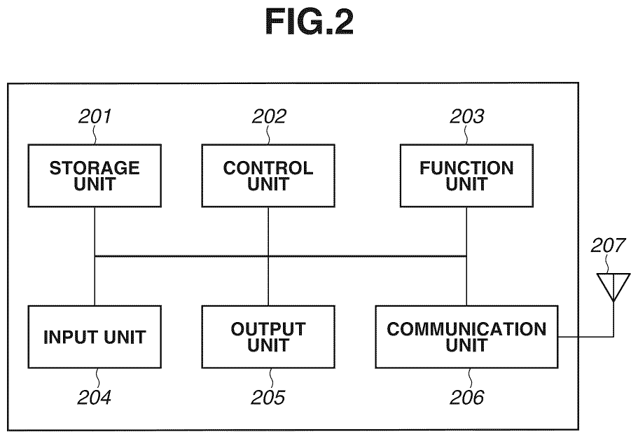

FIG. 2 illustrates an example hardware configuration of the communication apparatus 101 serving as an AP according to the present exemplary embodiment. The communication apparatuses 102 to 104 serving as STAs also have a similar configuration. The communication apparatus 101 includes a storage unit 201, a control unit 202, a function unit 203, an input unit 204, an output unit 205, a communication unit 206, and an antenna 207.

The storage unit 201 including memories, such as a Read Only Memory (ROM) and a Random Access Memory (RAM), stores computer programs for processing of flowcharts (described below) and other various operations, and various information, such as communication parameters for wireless communication. Storage media applicable as the storage unit 201 include not only a ROM and a RAM but also a flexible disk, a hard disk, an optical disk, a magneto-optical disk, a compact disc read only memory (CD-ROM), a compact disc recordable (CD-R), a magnetic tape, a nonvolatile memory card, and a digital versatile disc (DVD). The storage unit 201 may also include a plurality of different memories.

The control unit 202 includes, for example, one or more processors, such as a Central Processing Unit (CPU) and a Micro Processing Unit (MPU), and controls entire operation of the communication apparatus 101 by executing computer programs stored in the storage unit 201. The control unit 202 may control entire operation of the communication apparatus 101 through the collaboration between the computer programs and an Operating System (OS) stored in the storage unit 201. The control unit 202 also generates data and signals to be transmitted in communication with the other communication apparatus. The control unit 202 may also include a plurality of processors, such as multi-core processors, and control entire operation of the communication apparatus 101 by using the plurality of processors. The control unit 202 also controls the function unit 203 to perform predetermined processing, such as wireless communication, imaging, printing, and projection.

The function unit 203 is a hardware component by which the communication apparatus 101 performs predetermined processing. The function unit 203 performs at least one of the imaging function, printing function, scanning function, and projection function. For example, the function unit 203 transmits image data formed by using the imaging function and scanning function to an external apparatus via the communication unit 206 and prints image data received from an external apparatus via the communication unit 206 by using the printing function.

The input unit 204 receives various operations from the user. For example, the input unit 204 includes a touch panel, a keyboard, and hardware keys. The output unit 205 outputs various data to the user via a display and a speaker. Information output by the output unit 205 may include display on a monitor screen, an audio output to the speaker, and a vibratory output. The input unit 204 and the output unit 205 may be implemented as a single module like a touch panel. Each of the input unit 204 and the output unit 205 may also be integrated with the communication apparatus 101 or separated from each other.

The communication unit 206 controls wireless communication conforming to the IEEE 802.11 standard. The communication unit 206 may also control wireless communication conforming to other IEEE 802.11 series standards in addition to the IEEE 802.11 standard and control wired communication such as a wired LAN. The communication unit 206 controls the antenna 207 to communicate wireless signals for wireless communication generated by the control unit 202.

In a case where the communication apparatus 101 conforms to the NFC or Bluetooth® standard in addition to the IEEE 802.11be standard, the communication unit 206 may control wireless communication conforming to these communication standards. In a case where the communication apparatus 101 performs wireless communication conforming to a plurality of communication standards, the communication apparatus 101 may include communication units 206 and antennas 207 each pair of which conforms to a different one of these communication standards. The communication apparatus 101 communicates image data, document data, and video data with the communication apparatuses 102 to 104 via the communication unit 206.

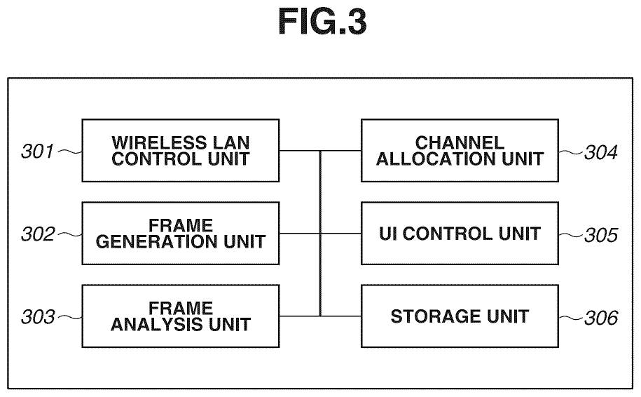

FIG. 3 is a block diagram illustrating a functional configuration of the communication apparatus 101 serving as an AP according to the present exemplary embodiment. FIG. 3 illustrates, for example, a functional configuration implemented when one or more processors execute programs stored in one or more memories. A similar configuration is applicable to the communication apparatuses 102 to 104 serving as STAs. Although the AP 101 includes a wireless LAN control unit 301, the AP 101 may include two or more wireless LAN control units 301. The AP 101 further includes a frame generation unit 302, a frame analysis unit 303, a channel allocation unit 304, a User Interface (UI) control unit 305, and a storage unit 306.

The wireless LAN control unit 301 includes an antenna and a circuit for communicating wireless signals with other wireless LAN apparatuses, and programs for controlling the antenna and the circuit. The wireless LAN control unit 301 performs wireless LAN communication control based on a frame generated by the frame generation unit 302 according to the IEEE 802.11 standard series.

The frame generation unit 302 generates a wireless communication control frame to be transmitted by the wireless LAN control unit 301. The contents of wireless communication control to be formed by the frame generation unit 302 may be restricted based on the settings stored in the storage unit 306. The contents may be changed based on user settings from the UI control unit 305.

The frame analysis unit 303 interprets the frame received by the wireless LAN control unit 301 and reflects the contents of the frame to the wireless LAN control unit 301. Even with a frame received by any control unit, once the frame is processed by the frame analysis unit 303, the wireless LAN control unit 301 which is not the one having received the frame is also able to perform control.

When issuing an instruction to communicate with a communication partner or an STA, the channel allocation unit 304 determines an appropriate channel to be used for the communication between the AP and the STA. Based on the determined allocation, for example, the AP 101 and the STA 102 perform communication by using the channel, which has been allocated to the AP 101 and the STA 102, or a sub channel specified in the channel.

The UI control unit 305 performs control relating to user interfaces, such as a touch panel and buttons, for receiving a user operation on the AP 101. For example, the UI control unit 305 also has a function of displaying an image and a function of presenting information, such as a sound output, to the user.

The storage unit 306 stores various types of data.

### First Exemplary Embodiment

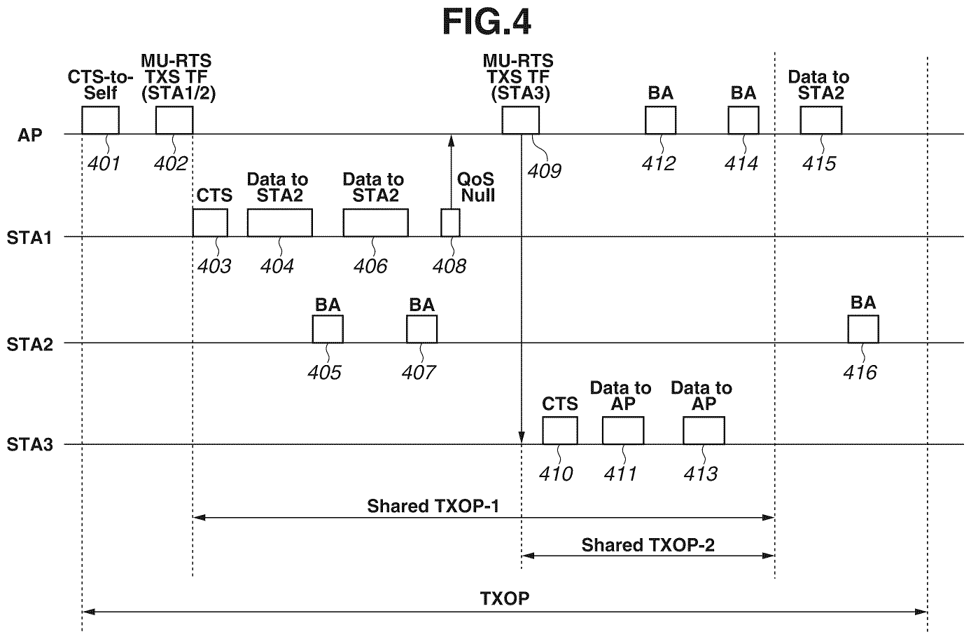

A first exemplary embodiment will be described below with reference to the drawing in FIG. 4. Referring to FIG. 4, “AP” indicates the communication apparatus 101, and “STAs 1 to 3” indicate the communication apparatuses 102 to 104, respectively.

According to the present exemplary embodiment, the AP 101 allocates an acquired TXOP to the STAs 1 and 2 to share the TXOP, and communication is performed between the STA 1 and the STA 2. The communication between the STAs 1 and 2 ends before the shared TXOP ends, and the STA 1 transmits to the AP 101 a frame indicating that the shared TXOP is to be returned to the AP 101. In response to receipt of this frame, the AP 101 allocates the TXOP to the STA 3 to share the TXOP, and the STA 3 transmits a data frame to the AP 101. Frame exchange between apparatuses relating to these pieces of processing will be described below.

The AP 101 transmits a CTS-to-self frame 401 to acquire the TXOP. Subsequently, the AP 101 transmits an MU-RTS TXS Trigger frame 402 to the STAs 1 and 2, and the STA 1 transmits a CTS frame 403. The MU-RTS TXS Trigger frame 402 transmitted from the AP 101 causes the STAs 1 and 2 to share the TXOP, whereby data exchange between the STAs 1 and 2 is enabled. In this processing, the length of the TXOP to be shared is also set. MU-RTS includes a subfield called the Triggered TXOP Sharing Mode subfield. In a case where MU-RTS indicates 1, the STA operates in a mode for transmission of a PLCP protocol data unit (PPDU) to the AP. In a case where MU-RTS indicates 2, the STA operates in a mode for transmission of the PPDU to the AP or other STAs that share the TXOP. In the present exemplary embodiment, the value of the subfield is 2, and thus data frames are communicated between the STAs 1 and 2. More specifically, the STA 1 transmits a data frame 404 to the STA 2 which then transmits a Block Ack (BA) 405 to the STA 1. Subsequently, the STA 1 transmits a data frame 406 to the STA 2 which then transmits a BA 407 to the STA 1. The data frames 404 and 406 are non-TB PPDUs. At the start of sharing the TXOP, although the STA 3 not subjected to the TXOP sharing may or may not enter a network allocation vector (NAV, transmission prohibition period), the STA 3 is able to receive data. In a case where the STA 3 enters the NAV, the STA 3 transmits no data.

At this timing, the STA 1 completes the transmission of all data frames to the STA 2, and there still remains a part of the shared TXOP (Shared TXOP-1 in FIG. 4). Examples of such a case include a case where data transmission fails during data transmission, and a case where data communication ends early because of a data rate higher than an estimated value. In a case where data exchange between STAs 1 and 2 has ended, the STA 1 transmits a QoS Null frame 408 to the AP 101 in order to end the Triggered TXOP sharing. The AP 101 is notified that the TXOP sharing ends, by 0 indicated in the RDG/More PPDU subfield in the CAS control field, which indicates a command and a status, in the HE variant HT control field of the QoS Null frame 408. The notification causes the AP 101 to set the TXOP Return Support In TXOP Sharing Mode 2 field in the EHT Capability Information field to 1 to interpret that the TXOP sharing ends. The method for notifying of the end of the Triggered TXOP sharing is not limited to this method but other methods are applicable.

In response to receipt of the QOS Null frame 408, the AP 101 sets again the STA with which the TXOP is to be shared in the Triggered TXOP sharing, and the length of the TXOP to be shared. In this processing, the AP 101 identifies an STA that is to perform data communication by using the TXOP, sets a value to the TXOP Sharing Mode subfield, and sets the length of the TXOP to be used. Alternatively, the AP 101 may determine to end the Triggered TXOP sharing. According to the present exemplary embodiment, the AP 101 shares the TXOP with the STA 3. The AP 101 sets the length of the TXOP to be shared in such a manner that the ending time of a newly set TXOP sharing period (Shared TXOP-2 in FIG. 4) coincides with the ending time of the initially set TXOP sharing period (Shared TXOP-1 in FIG. 4). However, the present invention is not limited thereto. The ending time of Shared TXOP-2 in FIG. 4 may be set before or after the ending time of Shared TXOP-1 in FIG. 4.

The AP 101 transmits an MU-RTS TXS Trigger frame 409 to the STA 3 to notify the STA 3 of the TXOP sharing. The STA 3 transmits a CTS frame 410 to the AP 101. According to the present exemplary embodiment, subsequently, the STA 3 performs uplink communication to the AP 101. More specifically, the STA 3 transmits data frames 411 and 413 to the AP 101, and the AP 101 transmits Block Ack frames 412 and 414 to the STA 3. The data frames 411 and 413 are non-TB PPDUs. In a case where the shared TXOP, i.e., Shared TXOP-2 and Shared TXOP-1 in FIG. 4, ends, there is no STA sharing the TXOP of the AP 101. However, in this state, the TXOP of the AP 101 (TXOP in FIG. 4) continues, and subsequent communication is enabled. While, in FIG. 4, the AP 101 transmits a data frame 415 to the STA 2, the present exemplary embodiment is not limited thereto. The present exemplary embodiment may be configured to set another STA that is to share the TXOP, and the length of a new TXOP, to perform data communication.

While, in the above-described example, the STAs 1 and 2 share the TXOP, and then the STA 3 and the AP 101 share the TXOP, the sharing may be performed in reverse order. The STAs 1 and 3 may share the TXOP after the STAs 1 and 2 share the TXOP. Alternatively, the STA 1 and the AP 101 may share the TXOP after the STA 3 and the AP 101 share the TXOP. The direction of data frame transmission is not limited to the above-described examples.

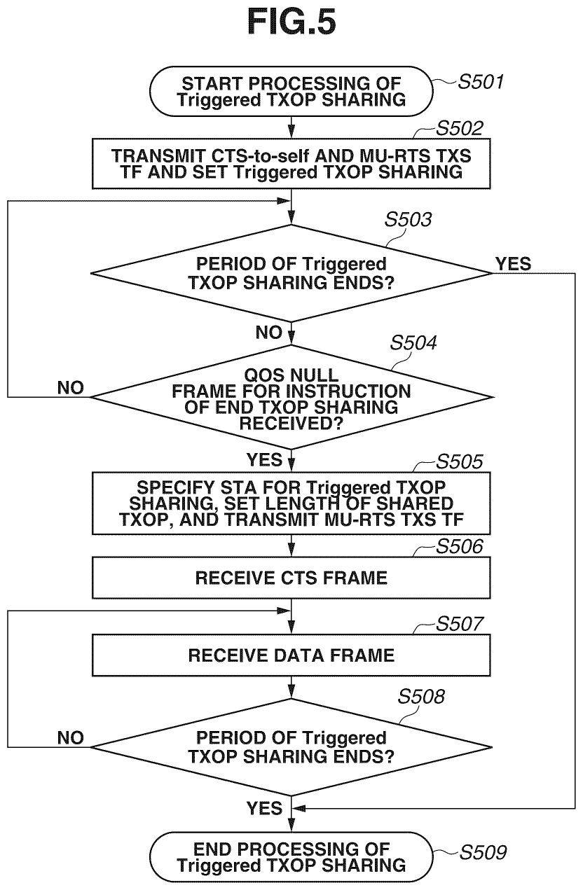

FIG. 5 is a flowchart illustrating processing of the present exemplary embodiment. The processing of this flowchart is executed, for example, by the communication apparatus 101 serving as the AP 101. An example of the data exchange processing illustrated in FIG. 4 will be described below. While an example of processing performed by the wireless LAN control unit 301 will be described below, the processing is not limited thereto. The processing may be performed by other function units or may be performed by a plurality of function units. The wireless LAN control unit 301 starts the Triggered TXOP sharing processing based on, for example, the data and the data amount to be transmitted by the AP 101 and the STAs, and the communication statuses of the AP 101 and the STAs.

In step S501, the wireless LAN control unit 301 starts the Triggered TXOP sharing processing. In step S502, the wireless LAN control unit 301 transmits the CTS-to-self frame 401 and the MU-RTS TXS Trigger frame 409. The wireless LAN control unit 301 specifies an STA that is to use the TXOP, based on whether a direct link between STAs has been set up, whether there is data to be transmitted to the STA, and whether there is data to be received from the STA, and then transmits the MU-RTS TXS Trigger frame 409 to the STA. In this case, the wireless LAN control unit 301 determines that a direct link using a Tunneled Direct Link Setup (TDLS) mechanism has been set up between the STAs 1 and 2, and sets up the Triggered TXOP sharing between the STAs 1 and 2. The STAs 1 and 2 share the TXOP by the setup. In this processing, the period during which the TXOP is shared is also set.

In step S503, the wireless LAN control unit 301 determines whether the Triggered TXOP sharing period ends. The Triggered TXOP sharing period refers to the period set in step S502. In a case where the AP 101 determines that the period ends (YES in step S503), the processing proceeds to step S509. In step S509, the AP 101 ends the Triggered TXOP sharing processing. In a case where the period does not end (NO in step S503), the processing proceeds to step S504.

In step S504, the wireless LAN control unit 301 determines whether the AP 101 has received a frame indicating the end of the TXOP sharing from an STA. In this case, the wireless LAN control unit 301 determines whether a frame indicating TXOP sharing return has been received from the STA 1 or 2. More specifically, the wireless LAN control unit 301 determines whether the QoS Null frame 408 has been received.

In a case where the frame indicating the end of the TXOP sharing has been received (YES in step S504), the processing proceeds to step S505. In step S505, the wireless LAN control unit 301 specifies the STA that is to perform the Triggered TXOP sharing, and then shares the TXOP. Like step S502, the wireless LAN control unit 301 specifies the STA that is to use the TXOP, based on whether a direct link between STAs has been set up, whether there is data to be transmitted to the STA, and whether there is data to be received from the STA. A description is given of a case in which the wireless LAN control unit 301 determines that the AP 101 has received Buffer Status Report from the STA 3 in advance, and the AP 101 has data to be transmitted to the STA 3. Then, the wireless LAN control unit 301 specifies the STA 3 as an STA that is to use the TXOP and transmits the MU-RTS TXS Trigger frame to the STA 3. In this processing, the period during which the TXOP is to be shared is also set, for example, in such a manner that the ending period coincides with the ending time of the period specified in step S502. While another STA that is to use the TXOP is specified in step S505, the present exemplary embodiment is not limited thereto. The AP 101 may specify an STA in advance, for example, in step S502.

In step S506, the wireless LAN control unit 301 receives a CTS frame from the STA 3. In step S507, the wireless LAN control unit 301 receives a data frame from the STA sharing the TXOP, i.e., the STA 3.

In step S508, the wireless LAN control unit 301 determines whether the Triggered TXOP sharing period ends. The Triggered TXOP sharing period refers to the period set in step S505. In a case where the wireless LAN control unit 301 determines that the shared TXOP ends (YES in step S508), the processing proceeds to step S509. In step S509, the wireless LAN control unit 301 ends the Triggered TXOP sharing processing. Then, the processing exits this flowchart. In a case where the wireless LAN control unit 301 determines that the period does not end (NO in step S508), the processing returns to step S507. While the wireless LAN control unit 301 ends the processing when the wireless LAN control unit 301 determines that the shared TXOP ends, the present exemplary embodiment is not limited thereto. The wireless LAN control unit 301 may specify another apparatus that is to share the TXOP and then newly perform the TXOP sharing.

According to the present exemplary embodiment, even in a case where, after the processing for setting the TXOP sharing, the communication by the sharing ends earlier than an estimated timing, setting the TXOP sharing is performed again, which enables effective use of the remaining TXOP, whereby the communication efficiency is ensured.

### Second Exemplary Embodiment

According to the first exemplary embodiment, the AP 101 determines the end of the data communication between STAs, based on a notification from the STAs. In a second exemplary embodiment, a description will be given centering on an example where the determination of whether the end of the data communication between STAs is performed based on absence of data reception for a predetermined time period in the AP 101 from the STAs sharing the TXOP. Because the basic configuration of the present exemplary embodiment is the same as that of the first exemplary embodiment, the differences will be described below, and the redundant description will be omitted.

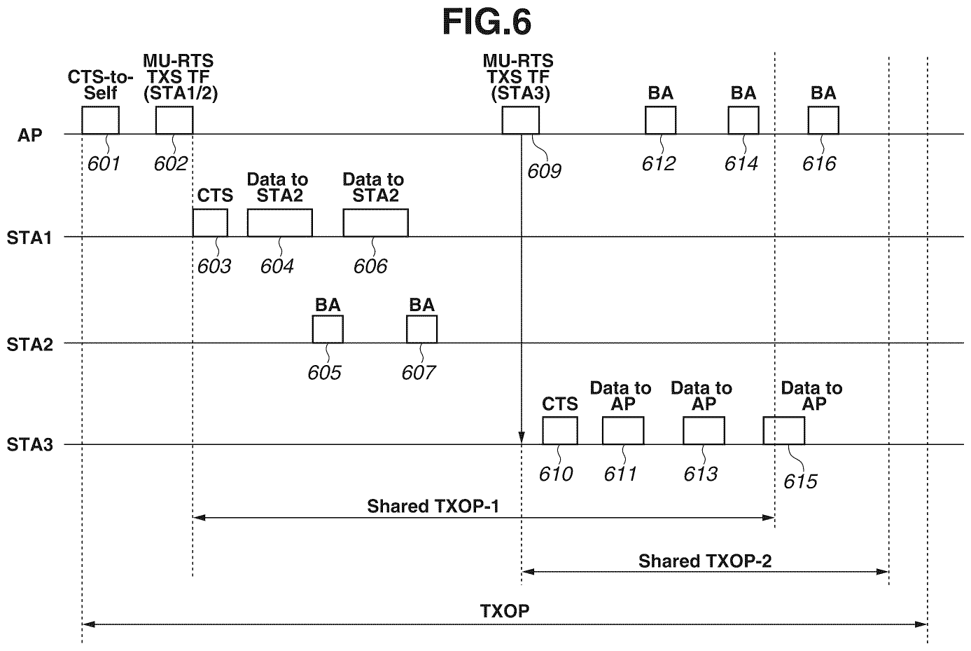

The second exemplary embodiment will be described below with reference to the drawing in FIG. 6. The procedure in the present exemplary embodiment up to the processing where the STAs 1 and 2 share the TXOP and perform data communication is similar to the first exemplary embodiment. Frames 601 to 607 in FIG. 6 are similar to the frames 401 to 407 in FIG. 4, respectively, and the redundant descriptions will be omitted.

After the STA 2 transmits Block Ack 607, the communication between the STAs 1 and 2 ends, and the STAs 1 and 2 do not perform frame transmission. Then, in a case where the AP 101 receives no frame for a predetermined time period, the AP 101 determines that the STA sharing the TXOP ends communication, and determines to end the TXOP sharing. Then, the AP 101 determines to share the remaining TXOP with the STA 3. The ending time of the TXOP to be shared with the STA 3 may be different from the ending time of the TXOP shared with the STAs 1 and 2. Referring to FIG. 6, the ending time of the TXOP to be shared with the STA 3 is set after the ending time of the TXOP shared with the STAs 1 and 2. Alternatively, the ending time of the TXOP to be shared with the STA 3 may be set before the ending time of the TOXP shared with the STAs 1 and 2. More specifically, any desired setting is applicable as long as these ending timings are earlier than the ending time of the TXOP acquired by the AP 101 (TXOP in FIG. 6).

The AP 101 transmits an MU-RTS TXF TF frame 609 to the STA 3, and the STA 3 transmits a CTS frame 610 to the AP 101. The STA 3 transmits data frames 611, 613, and 615 to the AP 101, and the AP 101 transmits corresponding Block Ack frames 612, 614, and 616 to the STA 3.

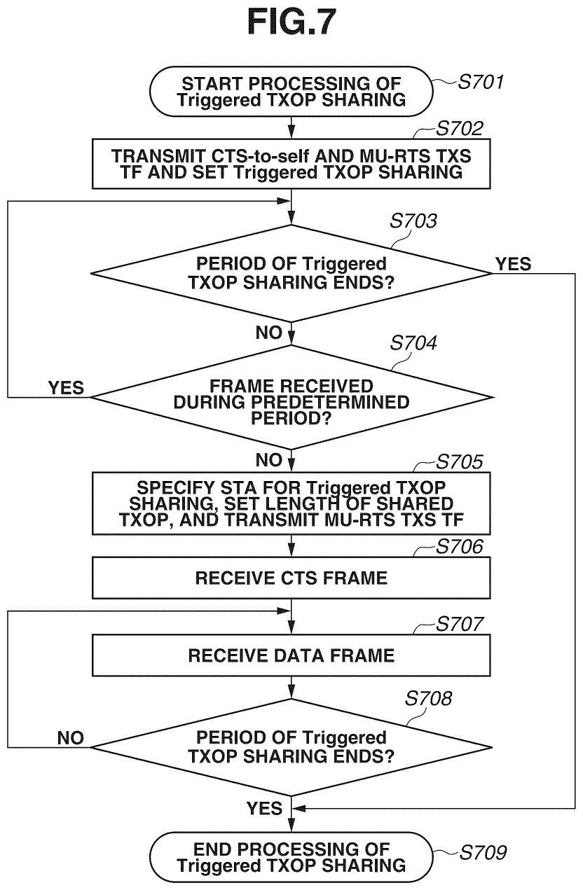

FIG. 7 is a flowchart illustrating the processing of the present exemplary embodiment. The processing of this flowchart is executed, for example, by the communication apparatus 101 serving as the AP 101, and illustrates the data exchange illustrated in FIG. 6. The basic configuration of the flowchart is the same as that of the flowchart in FIG. 5, and only differences will be described below.

In step S704, the wireless LAN control unit 301 determines whether a frame has been received for a predetermined time period during the Triggered TXOP sharing period. In a case where a frame has been received (YES in step S704), the processing returns to step S703. In a case where no frame has been received for a predetermined time period (NO in step S704), the processing proceeds to step S705. In step S705, like step S505, the wireless LAN control unit 301 specifies the STA 3 as an STA different from the STAs 1 and 2, which is to perform the Triggered TXOP sharing, sets the length of the TXOP to be shared, and transmits MU-RTS TXS TF to the STA 3.

According to the present exemplary embodiment, before the Triggered TXOP sharing ends, in a case where the AP 101 which has acquired the TXOP detects absence of transmission frame of an STA sharing the TXOP for a predetermined time period, the AP 101 determines that the STA sharing the TXOP has ended the communication and determines to end the use of the TXOP, the AP 101 sets again the length of the TXOP to be shared and set an STA different from the STA sharing the TXOP as another STA with which the TXOP is to be shared.

### Other Exemplary Embodiments

The above-described first and second exemplary embodiments may be combined. More specifically, the communication apparatus 101 may be configured to determine that an STA sharing the TXOP ends communication, based on a receipt of a frame indicating the end of the TXOP sharing from the STA or absence of receipt of frames from the STA for a predetermined time period.

A recording medium storing the program code of software for implementing the above-described functions may be supplied to a system or an apparatus, and the computer (CPU or MPU) of the system or the apparatus may read and execute the program code stored in the recording medium. In this case, the program code itself read from the storage medium implements the functions of the above-described exemplary embodiments, and the storage medium storing the program code configures the above-described apparatus.

Examples of recording media for supplying the program code include a flexible disk, a hard disk, an optical disk, a magneto-optical disk, a compact disc read only memory (CD-ROM), a compact disc recordable (CD-R), a magnetic tape, a nonvolatile memory card, a read only memory (ROM), a digital versatile disc (DVD).

The functions of the above-described exemplary embodiments may be implemented not only when the computer executes the read program code but also when the operating system (OS) operating on the computer executes part or whole of actual processing based on instructions of the program code. OS is an abbreviation for Operating System.

Further, the program code read from the storage medium is written to a memory included in a function expansion board inserted into the computer or a function expansion unit connected to the computer. The CPU included in the function expansion board or the function expansion unit may implement the above-described functions by executing part or whole of actual processing based on instructions of the program code.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described exemplary embodiment(s) and/or that includes one or more circuits (e.g., application specific integrated circuit (ASIC)) for performing the functions of one or more of the above-described exemplary embodiment(s), and by a method performed by the computer of the system or apparatus by, for example, reading out and executing the computer executable instructions from the storage medium to perform the functions of one or more of the above-described exemplary embodiment(s) and/or controlling the one or more circuits to perform the functions of one or more of the above-described exemplary embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed calculating systems, an optical disk (such as a compact disc (CD), a digital versatile disc (DVD), or a Blu-ray Disc™ (BD)), a flash memory apparatus, a memory card.

The disclosure of the present exemplary embodiment includes the following configurations, methods, and programs.

### (Configuration 1)

A communication apparatus includes a first transmission unit configured to transmit a first Trigger frame conforming to the IEEE 802.11 series standard, the first Trigger frame instructing that at least one first communication apparatus participating in a wireless network performs communication by using a first time period which is at least a part of a Transmission Opportunity (TXOP) acquired by the communication apparatus, and a second transmission unit configured to transmit, in a case where communication of data to be communicated during the first time period ends, a second Trigger frame instructing that a second communication apparatus different from the first communication apparatus newly performs communication by using a second time period which is at least a part of the acquired TXOP.

### (Configuration 2)

The communication apparatus according to configuration 1, further includes a determination unit configured to determine that the communication of the data to be communicated during the first time period ends, wherein in a case where the determination unit determines the end, the second transmission unit transmits the second Trigger frame.

### (Configuration 3)

The communication apparatus according to configuration 2, wherein the determination unit determines the end, based on a receipt of a frame indicating an end of using the TXOP from the first communication apparatus.

### (Configuration 4)

The communication apparatus according to the configuration 3, wherein the frame is a QoS Null frame.

### (Configuration 5)

The communication apparatus according to configuration 2, the determination unit determines the end, based on absence of a receipt of a predetermined frame from the first communication apparatus for a predetermined time period.

### (Configuration 6)

The communication apparatus according to any one of configurations 1 to 5, wherein the Trigger frame is an MU-RTS TXS Trigger frame.

### (Configuration 7)

The communication apparatus according to any one of configurations 1 to 6, wherein the communication apparatus is an access point that forms a network.

### (Configuration 8)

The communication apparatus according to any one of configurations 1 to 7, wherein, in the first time period, the first communication apparatus shares the TXOP with a third communication apparatus different from the first communication apparatus.

### (Configuration 9)

The communication apparatus according to any one of configurations 1 to 8, wherein, in the second time period, the communication apparatus shares the TXOP with a third communication apparatus different from the first communication apparatus.

### (Configuration 10)

The communication apparatus according to any one of configurations 1 to 9, wherein an ending time of the second time period is set to be a same as or earlier than an ending time of the first time period.

### (Configuration 11)

The communication apparatus according to any one of configurations 1 to 10, wherein the ending time of the second time period is set to be earlier than an ending time of a period of the acquired TXOP.

### (Configuration 12)

A communication apparatus comprising:
a receiving unit configured to receive a Trigger frame conforming to the IEEE 802.11 series standard, the Trigger frame instructing that communication is performed by sharing a first time period, which is at least a part of a TXOP acquired by the first communication apparatus having a role of establishing a wireless network, with at least one second communication apparatus different from the communication apparatus participating in the wireless network;
an execution unit configured to execute communication with the second communication apparatus based on the Trigger frame; and
a transmission unit configured to transmit, in a case where the communication by the execution unit ends, a frame indicating the end to the first communication apparatus.

### (Method 1)

A control method of a communication apparatus comprising:
transmitting, as first transmitting, a first Trigger frame conforming to the IEEE 802.11 series standard, the first Trigger frame instructing that at least one first communication apparatus participating in a wireless network performs communication by using a first time period which is at least a part of a Transmission Opportunity (TXOP) acquired by the communication apparatus; and
transmitting, as second transmitting, in a case where communication of data to be communicated during the first time period ends, a second Trigger frame instructing that a second communication apparatus different from the first communication apparatus performs communication by using a second time period which is at least a part of the acquired TXOP.

### (Method 2)

A control method of a communication apparatus comprising:
receiving a Trigger frame conforming to the IEEE 802.11 series standard, the Trigger frame instructing that communication is performed by sharing a first time period, which is at least a part of a TXOP acquired by a first communication apparatus having a role of establishing a wireless network, with at least one second communication apparatus different from the communication apparatus participating in the wireless network;
executing communication with the second communication apparatus based on the Trigger frame; and
transmitting, in a case where the communication by the executing ends, a frame indicating the end to the first communication apparatus.

### (Program)

A program that causes a computer to perform each unit of the communication apparatus according to any one of configurations 1 to 12.

According to the present disclosure, sharing a TXOP and performing communication is performed without degrading the communication efficiency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A communication apparatus comprising:
one or more memories that store a set of instructions; and
at least one processing circuit, wherein the communication apparatus is caused, by the at least one processing circuit executing the instructions and/or the at least one processing circuit itself operating, to perform operations comprising:
transmitting a first Trigger frame conforming to the IEEE 802.11 series standard, the first Trigger frame instructing that at least one first communication apparatus participating in a wireless network performs communication by using a first time period which is at least a part of a Transmission Opportunity (TXOP) acquired by the communication apparatus; and
transmitting, in a case where communication of data to be communicated during the first time period ends, a second Trigger frame instructing that a second communication apparatus different from the first communication apparatus performs communication by using a second time period which is at least a part of the acquired TXOP.

2. The communication apparatus according to claim 1, wherein the communication apparatus is further caused to perform:
determining that the communication of the data to be communicated during the first time period ends; and
transmitting, in a case where the end is determined, the second Trigger frame.

3. The communication apparatus according to claim 2, wherein the communication apparatus is further caused to perform:
determining the end based on a receipt of a frame indicating an end of using the TXOP from the first communication apparatus.

4. The communication apparatus according to claim 3, wherein the frame is a QoS Null frame.

5. The communication apparatus according to claim 2, wherein the communication apparatus is further caused to perform:
determining the end, based on absence of a receipt of a predetermined frame from the first communication apparatus for a predetermined time period.

6. The communication apparatus according to claim 1, wherein the Trigger frame is an MU-RTS TXS Trigger frame.

7. The communication apparatus according to claim 1, wherein the communication apparatus is an access point that forms a network.

8. The communication apparatus according to claim 1, wherein, in the first time period, the first communication apparatus shares the TXOP with a third communication apparatus different from the first communication apparatus.

9. The communication apparatus according to claim 1, wherein, in the second time period, the communication apparatus shares the TXOP with a third communication apparatus different from the first communication apparatus.

10. The communication apparatus according to claim 1, wherein an ending time of the second time period is set to be a same as or earlier than an ending time of the first time period.

11. The communication apparatus according to claim 1, wherein the ending time of the second time period is set to be earlier than an ending time of a period of the acquired TXOP.

12. A communication apparatus comprising:
one or more memories that store a set of instructions; and
at least one processing circuit, wherein the communication apparatus is caused, by the at least one processing circuit executing the instructions and/or the at least one processing circuit itself operating, to perform operations comprising:
receiving a Trigger frame conforming to the IEEE 802.11 series standard, the Trigger frame instructing that communication is performed by sharing a first time period, which is at least a part of a TXOP acquired by the first communication apparatus having a role of establishing a wireless network, with at least one second communication apparatus different from the communication apparatus participating in the wireless network;
executing communication with the second communication apparatus based on the Trigger frame; and
transmitting, in a case where the communication with the second communication apparatus based on the Trigger frame ends, a frame indicating the end to the first communication apparatus.

13. A control method of a communication apparatus comprising:
transmitting, as first transmitting, a first Trigger frame conforming to the IEEE 802.11 series standard, the first Trigger frame instructing that at least one first communication apparatus participating in a wireless network performs communication by using a first time period which is at least a part of a Transmission Opportunity (TXOP) acquired by the communication apparatus; and
transmitting, as second transmitting, in a case where communication of data to be communicated during the first time period ends, a second Trigger frame instructing that a second communication apparatus different from the first communication apparatus performs communication by using a second time period which is at least a part of the acquired TXOP.

14. A control method of a communication apparatus comprising:
receiving a Trigger frame conforming to the IEEE 802.11 series standard, the Trigger frame instructing that communication is performed by sharing a first time period, which is at least a part of a TXOP acquired by a first communication apparatus having a role of establishing a wireless network, with at least one second communication apparatus different from the communication apparatus participating in the wireless network;
executing communication with the second communication apparatus based on the Trigger frame; and
transmitting, in a case where the communication with the second communication apparatus based on the Trigger frame ends, a frame indicating the end to the first communication apparatus.

15. A non-transitory computer readable storage medium that stores a program that causes, when the program is executed, a communication apparatus to perform:
transmitting a first Trigger frame conforming to the IEEE 802.11 series standard, the first Trigger frame instructing that at least one first communication apparatus participating in a wireless network performs communication by using a first time period which is at least a part of a Transmission Opportunity (TXOP) acquired by the communication apparatus; and
transmitting, in a case where communication of data to be communicated during the first time period ends, a second Trigger frame instructing that a second communication apparatus different from the first communication apparatus performs communication by using a second time period which is at least a part of the acquired TXOP.
